(19) United States
(12) Patent Application Publication
(10) Pub. No.: US 2018/0059284 A1
(43) Pub. Date: Mar. 1, 2018

(54) EVALUATION METHOD OF GLACIER STORAGE VARIATION BASED ON BASIN WATER-BALANCE PRINCIPLE

(71) Applicant: China Institute of Water Resources and Hydropower Research, Beijing (CN)

(72) Inventors: Denghua YAN, Beijing (CN); Meng LI, Beijing (CN); Wanli SHI, Beijing (CN); Tianling QIN, Beijing (CN); Baisha WENG, Beijing (CN); Hao WANG, Beijing (CN); Shaohua LIU, Beijing (CN)

(73) Assignee: China Institute of Water Resources and Hydropower Research, Beijing (CN)

(21) Appl. No.: 15/655,905

(22) Filed: Jul. 21, 2017

(30) Foreign Application Priority Data
Aug. 12, 2016 (CN) 2016106644410

(51) Int. Cl. G01V 99/00; G01W 1/02; G01W 1/18

(52) U.S. Cl. CPC G01V 99/005; G01W 1/18; G01W 1/02

(57) ABSTRACT

The present invention relates to an evaluation method of glacier storage variation based on basin water-balance principle, including the following steps: (1) selecting a basin where glaciers exist wherein a hydrological station control cross-section is regarded as a basin outlet; (2) obtaining a precipitation, an evaporation and a soil water storage variation within a range of the basin during a predetermined period respectively; (3) obtaining a flow data monitored by hydrological stations at the basin outlet during a predetermined period and calculating runoff; and (4) calculating the glacier storage variation at the basin scale based on basin water-balance principle, according to the precipitation, the evaporation, the soil water storage variation and the runoff. It is significant to the researches on climate change, disaster prevention and mitigation.

### CROSS REFERENCE TO RELATED APPLICATIONS

This application is based upon and claims priority to Chinese Patent Application No. 2016106644410 (CN), filed on Aug. 12, 2016, the entire contents of which are incorporated herein by reference.

### TECHNICAL FIELD

The present invention relates to the field of remote sensing data acquisition, hydrology and water resources, and relates to an evaluation method of glacier storage variation based on basin water-balance principle.

### BACKGROUND

In the field of global warming, the accelerated melting of glaciers has an important influence on sea level rise, global water cycle, human life, and property safety. The glaciers are sensitive to the changes in regional environment, so they are considered as an indicator of climate changes. The response of the glaciers to climate change is the key for research on the variation of the glaciers. The changes in the volumes of glaciers are regarded as an important part of the glacier research, and are given more significance to related scholars.

In the current research, the research of the changes in glaciers is mainly focused on the areas and volumes of the glaciers. The main methods include the traditional measurement method, the empirical formula method, the glacier topography, and the remote sense monitoring method. These methods are very helpful for obtaining the volumes of the glaciers, but the accuracy and reliability of results need to be further improved. In fact, as to the volumes of the glaciers, the research should not only focus on the glacier storages, i.e., “stock”, but the researchers should also be more concerned about the glacier storage variation, i.e., “flux”.

### SUMMARY OF THE INVENTION

The technical problem that the present invention intends to solve is to provide an evaluation method of glacier storage variation based on basin water-balance principle. The method is provided and aimed at the research of the glacier “flux”, and the basin water-balance principle is applied to the calculation process of the glacier storage variation. Wherein, each water element is obtained by using various methods to validate each other, in order to improve the accuracy and reliability of the data. Therefore, a better accuracy of the glacier storage variation evaluation is provided.

The technical solution of the present invention for solving the above technical problem is as below: An evaluation method of glacier storage variation based on basin water-balance principle, includes the following steps:

step 1: selecting the basin where glaciers exist, wherein the hydrological station control cross-section is regarded as a basin outlet;

step 2: obtaining a precipitation, an evaporation and soil water storage variation within a range of the basin during a certain period;

step 3: obtaining a flow data monitored by the hydrological stations at the basin outlets during a certain period and counting a runoff;

step 4: calculating the glacier storage variation of the basin based on basin water-balance principle, according to the precipitation, the evaporation, the soil water storage variation and the runoff.

The benefits of the present invention: The spatial unit is the basin. The multiple methods to validate with each other are used for obtaining the precipitation, the evaporation, the soil water storage and the runoff. The multiple methods to validate with each other include the validating of the model and the measured data, the validating of the remote sense and the measured data, and so on. The basin water-balance principle is also applied in the process of estimating the glacier storage variation to improve the accuracy and reliability of the data, so that the variations i.e. the shrinking or expansion of glacier can be described quantitatively, which is significant to the researches on climate change, water supply in the arid area and ecological security, and provides a scientific basis for the rational management and sustainable utilization of the water resource, as well as for disaster prevention and mitigation.

Based on above technical solution, the present invention can be further improved as below.

Further, the precipitation of the step 2 is obtained through a checking method validating the measured station data and data from the satellite.

The benefit of the above further solution is that the satellite data is corrected by using the measured station data to obtain more accurate basin data.

Further, the measured station data is obtained from the monitoring data of the meteorological station; the data from the satellite includes data of TRMM, GSMaP, GPCP and CMORPH.

Further, the checking method is that the measured station data is used to correct the data from the satellite via a linear regression method.

Further, the evaporation of the step 2 is obtained through a checking method validating the monitoring data of the meteorological station and estimated data from a remote sensing based evaporation model.

The benefit of the above further solution is that the estimated data from the evaporation model are corrected by using the monitoring data to obtain more accurate basin data.

Further, the checking method is that the monitoring data of the meteorological station is used to correct the estimated data from the evaporation model via the least square method and a regression method.

Further, the remote sense is NOAA/AVHRR and Landsat, the evaporation model is a SEBAL model, wherein a formula used by the SEBAL model is as below:

Rₙ=λ·ET+G+H

In the formula, Rₙ is the net radiant energy, G is the soil heat flux, H is the sensible heat flux, wherein these three parameters are inverted by VIS, NIR and TIR bands of remote sensing data respectively; λ is the latent heat of vaporization of water, which is obtained by inquiring the query table of the latent heat of vaporization; ET is the evaporation capacity.

Further, the soil water storage variation in the step 2 is obtained by the method of remote sensing inversion and distributed hydrological simulation.

The benefit of the further solution is that the distributed hydrological simulation data are corrected by using the monitoring data to obtain more accurate basin data.

Further, WEP model is used in the distributed hydrological simulation, wherein a core algorithm uses Green-Ampt model and a formula as below:

I=(θₛ−θᵢ)Z_{f}

In the formula, I is the cumulative infiltration capacity of the soil water, θₛ is the saturated soil moisture content, θᵢ is the initial soil moisture content, Z_{f} is the depth of wetting front.

Further, the glacier storage variation of the basin of the step 4 is calculated with the following formula:

ΔV_{g}=(P−E−ΔVₛ−ΔVᵤ−Q)/k

Wherein, ΔV_{g} is the glacier storage variation, if it is positive, then the glacier storage increases, while if it is negative, then the glacier storage decreases; P is precipitation; E is evaporation; is soil water storage variation, if it is positive, then the soil water storage increases, ΔVₛ while if it is negative, then the soil water storage decreases; ΔVᵤ is the groundwater storage variation, if it is positive, then the groundwater storage increases, while if it is negative, then the groundwater storage decreases, since the changes of the groundwater in glacier area is little, even none, ΔVᵤ is thus regarded as 0; Q is runoff of the basin; k is the phase transition coefficient and the density of ice is 0.9 g/cm³, k is generally taken as 0.9.

### BRIEF DESCRIPTION OF THE DRAWINGS

FIG. 1 is a flow chart of the method of the present invention.

FIG. 2 is a schematic diagram of the method of the present invention.

### DETAILED DESCRIPTION OF THE INVENTION

The principle and characteristics of the present invention are described with reference to the drawings. The provided embodiments are just used for explaining the present invention, but not for limiting the scope of the present invention.

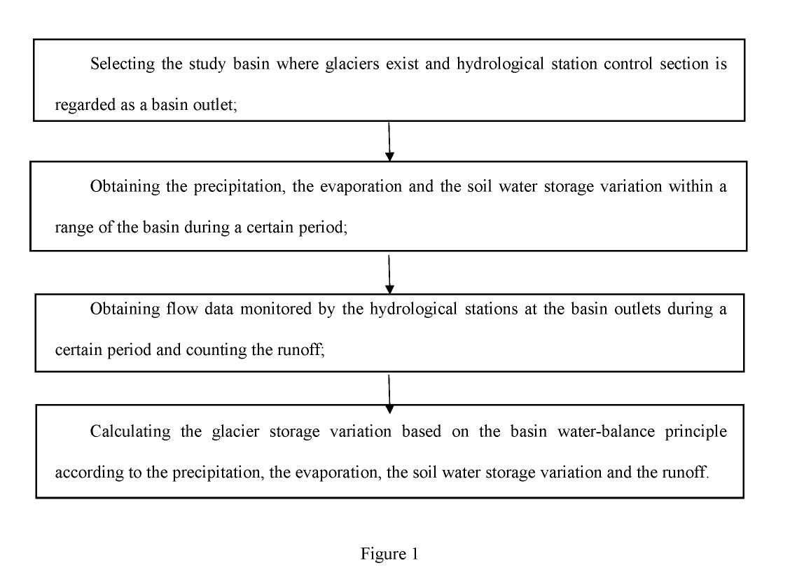

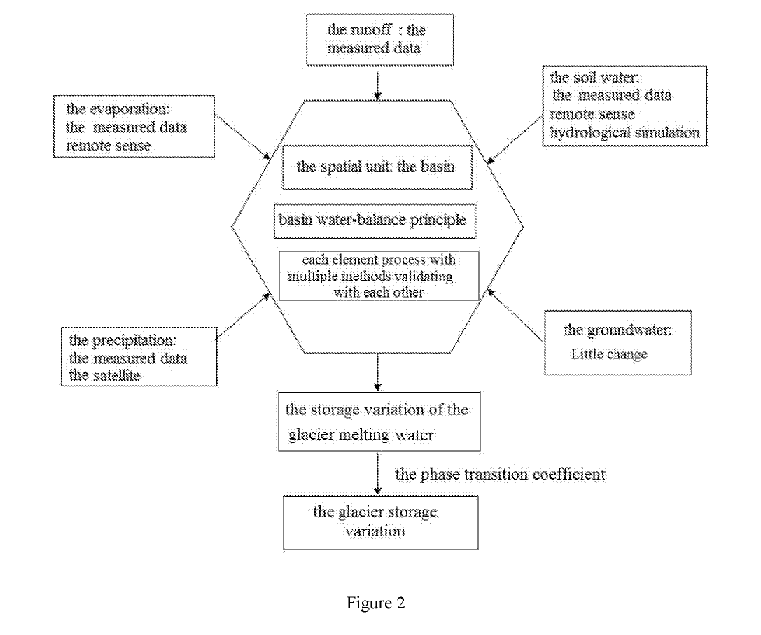

As shown in FIG. 1 and FIG. 2, the present invention is aimed to provide an evaluation method of glacier storage variation based on basin water-balance principle, calculating from the perspective of basin water-balance. The method provides some ideas and references for the research on the changes in the volumes of glaciers. At the same time, it can provide support for the research of regional climate changes and water resources evolution. The method is characterized by using basin water-balance principle, wherein the spatial unit is the basin. The method required for the acquisition of each element is obtained with multiple methods, validating with each other, including the validating of the model and the measured data, the validating of remote sensing and the measured data. The present invention includes the following steps:

Step 1: selecting the basin where glaciers exist, wherein hydrological station control cross-section is regarded as a basin outlet;

Step 2: obtaining a precipitation P within the range of the basin during a certain period. The precipitation data is mainly obtained by validating the measured data and the satellite data, wherein the measured data can be obtained from the monitoring data of meteorological station (China Meteorological Data Sharing Service System) and the satellite data including TRMM (Tropical Rainfall Measuring Mission) (disc2.nascom.nasa.gov/data/), GSMaP (Global Satellite Mapping of Precipitation) (sharaku.eorc.jaxa.jp/GSMaP_crest/index.html), GPCP Global Precipitation Climatology Project) (ftp.cpc.ncep.noaa.gov/precip/GPCP_PEN_RT/data), CMORPH (Climate Prediction Center Morphing Technique) (ftp.cpc.ncep.noaa.gov/precip/global_CMORPH) and so on, which can be obtained freely from the internet. The websites in the brackets are the website of data acquisition. The satellite data are corrected by using the measured data, and the correction method is linear regression method, which can obtain more accurate data from the basin.

An evaporation E within a range of the basin during a certain period is obtained. The evaporation data can be obtained through the monitoring data of the meteorological station (China Meteorological Data Sharing Service System) and can also be estimated from the evaporation model, such as SEBAL model, of the remote sensing, such as NOAA/AVHRR and Landsat. Validating is conducted. The checking method is that the monitoring data of the meteorological station is used to correct the estimated data from the evaporation model via the least square method and a regression method.

Wherein a formula of the SEBAL model is as below:

Rₙ=λ·ET+G+H

In the formula, Rₙ is the net radiant energy, G is the soil heat flux, H is the sensible heat flux, wherein these three parameters are inverted by VIS, NIR and TIR bands of remote sensing data (NOAA/AVHRR and Landsat) respectively; λ is the latent heat of vaporization of water, which is obtained by inquiring the query table of latent heat of vaporization; ET is the evaporation capacity.

A soil water storage variation within a range of the basin, during a certain period, is obtained. The soil water storage variation is mainly obtained by the method of remote sensing inversion and distributed hydrological simulation (like WEP model). Wherein the remote sensing inverted data can be downloaded from NASA Goddard Earth Science and Information Service Center (GES DISC) (disc.sci.gsfc.nasa.gov/) or National Snow and Ice Data Center (NSIDC)(n5eil01u.ecs.nsidc.org/SAN/AMSA/AE_Land3.002/). The WEP model can output the soil moisture content in a given period of time, wherein the core algorithm uses Green-Ampt model and the formula is provided as below:

I=(θₛ−θᵢ)Z_{f}

In the formula, I is the cumulative infiltration capacity of the soil water, θₛ is the saturated soil moisture content, θᵢ is the initial soil moisture content, Z_{f} is the depth of wetting front.

Step 3: obtaining a flow process monitored by the hydrological stations at the basin outlets during a certain period and counting a runoff Q, which can be obtained by referring to a relevant hydrologic data year book.

Step 4: calculating the glacier storage variation of the basin based on basin water-balance principle, according to the precipitation P, the evaporation E, the soil water storage variation ΔVs and the runoff Q.

Wherein the glacier storage variation of the basin is calculated using the following formula:

ΔV_{g}=(P−E−ΔVₛ−ΔVᵤ−Q)/k

Wherein, ΔV_{g} is the glacier storage variation, if it is positive, then the glacier storage increases, while if it is negative, then the glacier storage decreases; P is precipitation; E is evaporation; ΔVₛ is the soil water storage variation, if it is positive, then the soil water storage increases, while if it is negative, then the soil water storage decreases; ΔVᵤ is the groundwater storage variation, if it is positive, then the groundwater storage increases, while if it is negative, then the groundwater storage decreases, since the changes of the groundwater in glacier area is little, even none, ΔVᵤ is thus regarded as 0; Q is runoff of the basin; k is the phase transition coefficient and the density of ice is 0.9 g/cm³, k is generally taken as 0.9.

The working principle of the present invention is explained ahead. The basin water-balance principle in the glaciers is generally depends on precipitation, evaporation, water content in the soil, melting of glacier, runoff, groundwater and other elements. Multiple methods, validating with each other, are used to obtain the water amount corresponding to each element, except the amount of water corresponding to melting of glacier, to estimate the storage variation of the water corresponding to the melting of glacier. Wherein, the precipitation is obtained by validating the measured data and the inverted satellite data; the amount of water corresponding to evaporation is obtained by combining the measured data with remote sensing model; the soil water storage variation is obtained by the methods of inverted remote sensing data and distributed hydrological simulation. The runoff is obtained through counting the measured runoffs of hydrological control stations; most of the groundwater in the mountain glaciers region is exposed as a base flow and the underground water is almost unchanged, so the influence of the groundwater on estimating the glacier storage variation is little. Therefore, the storage variation of the water corresponding to glacier melting in the basin can be estimated based on basin water-balance principle, then the volume change of the glacier storage variation is obtained through liquid-solid transition coefficient.

The present invention provides an evaluation method for estimating mountain glacier storage variation, so that the extent of the shrinking or expansion of glacier can be described quantitatively, which is significant to the researches of climate change, water supply in the arid area and ecological security, and provides a scientific basis for water resource management and rational utilization, as well as disaster prevention and mitigation.

The present invention can be widely used in the research on volume change of mountain glaciers at middle and low latitudes, especially suitable for the evaluation of glacier evolution of the China's Qinghai-Tibet Plateau.

### Embodiment 1

A certain glacier of the China's Qinghai-Tibet Plateau is selected and taken as an example to illustrate the estimation process of the glacier storage variation in recent 10 years.

Step 1: The basin range where the glacier exists is extracted using GIS technology, in combination with DEM data and the positions of the hydrological stations, wherein the basin outlets are set as the position of the hydrological stations.

Step 2: According to the positions and numbers within the extracted range of the basin and the meteorological stations nearby, the daily precipitation data of each station in the last decade are downloaded from the China Meteorological Data Sharing Service System, and then the precipitation data are obtained from TRMM satellite in the last decade and the precipitation data are preliminarily processed to obtain the daily precipitation raster data in the last decade within the basin range. The TRMM satellite data can be downloaded freely through the website (disc2.nascom.nasa.gov/data/). The linear regression analysis is conducted on satellite precipitation data by means of the measured station data. The obtained linear parameters are applied to correct TRMM raster data to obtain corrected daily precipitation data in the basin, and then the corrected daily precipitation data is accumulated to obtain the total precipitation P in the last decade, which can also provide basic data for the subsequent establishment of hydrological model.

According to the extracted positions and the numbers of the meteorological stations, the evaporation data of all the stations in the last decade are downloaded from China Meteorological Data Sharing Service System and the daily evaporation in the basin is obtained by interpolation. If supported by the satellite data by remote sensing, the evaporation model SEBAL can be selected to calculate the evaporation in the basin, and validate the evaporation with the station data. The checking method is that the monitoring data of the meteorological station is used to correct the estimated data from the evaporation model by using the least square method and a regression method. Finally, the total evaporation E of the basin in the last decade is obtained. The basic data is thus provided for the subsequent establishment of hydrological model.

The basic data is prepared for the establishment of hydrological model. The hydrological model is established and calibrated. The soil water storage variation (AVs) of the basin in the last decade is obtained by the hydrological model. The soil water remote sensing data in the recent years are also downloaded from the National Snow and Ice Data Center (NSIDC) (n5ei101u.ecs.nsidc.org/SAN/AMSA/AE_Land3.002/), and validated with the soil moisture content simulated by model.

Step 3: Referring to relevant hydrologic data year book, the flow data monitored by the hydrological stations at the basin outlets during the last decade is obtained and the total runoff Q in the last decade is counted, and these data are used to establish the hydrologic model.

Step 4: According to the basin water-balance principle, the precipitation P, the evaporation E, the soil water storage variation ΔVs and the runoff Q obtained respectively from step 2 and step 3 are substituted into the formula of the glacier storage variation to calculate the glacier storage variation in the basin. The formula is as below:

ΔV_{g}=(P−E−ΔVₛ−ΔVᵤ−Q)/k

Wherein, ΔV_{g} is the glacier storage variation, if it is positive, then the glacier storage increases, while if it is negative, then the glacier storage decreases; P is precipitation; E is evaporation; ΔVₛ is the soil water storage variation, if it is positive, then the soil water storage increases, while if it is negative, then the soil water storage decreases; ΔVᵤ is the groundwater storage variation, if it is positive, then the groundwater storage increases, while if it is negative, then the groundwater storage decreases, since the changes of the groundwater in glacier area is little, even none, ΔVᵤ is thus regarded as 0; Q is the runoff of the basin; k is the phase transition coefficient and the ice density is 0.9 g/cm³, k is generally taken as 0.9.

An evaluation method of glacier storage variation based on basin water-balance principle provided above is described in detail in the present invention. The specific examples provided in this application illustrate the principle and the implementation of the present invention and the above description of the embodiment are only used to facilitate understanding the method of the present invention and the core idea. Further, according to the idea of the present invention, the modifications and improvements to the embodiments and applications of the present invention are possible by the ordinary skilled person in the art.

The above is only a preferred embodiment of the present invention and is not a limitation to the invention. Within the spirits and principles of the present invention, any modifications, equivalent replacements, improvements etc. should fall into the scope of the present invention.

What is claimed is:

1. An evaluation method of a glacier storage variation based on a basin water-balance principle, comprising following steps:
step 1: selecting a basin where glaciers exist, wherein a hydrological station control cross-section is regarded as a basin outlet;
step 2: obtaining a precipitation, an evaporation and a soil water storage variation within a range of the basin during a predetermined period;
step 3: obtaining a flow data monitored by hydrological stations at the basin outlet during a predetermined period and calculating runoff;
step 4: calculating the glacier storage variation at the basin based on the basin water-balance principle, according to the precipitation, the evaporation, the soil water storage variation and the runoff.

2. The evaluation method of glacier storage variation based on the basin water-balance principle of claim 1, wherein the precipitation of the step 2 is obtained through a checking method by validating measured stations data and data from a satellite.

3. The evaluation method of glacier storage variation based on basin water-balance principle of claim 2, wherein the measured stations data is obtained from a monitoring data of a meteorological station; the data from the satellite includes data of TRMM, GSMaP, GPCP and CMORPH.

4. The evaluation method of glacier storage variation based on basin water-balance principle of claim 2, wherein the checking method is that the measured stations data is used to correct the data from the satellite via a linear regression method.

5. The evaluation method of glacier storage variation based on basin water-balance principle of claim 1, wherein the evaporation of the step 2 is obtained through a checking method by validating a monitoring data of a meteorological station and an estimated data from an evaporation model of a remote sense.

6. The evaluation method of glacier storage variation based on basin water-balance principle of claim 5, wherein the checking method is that the monitoring data of the meteorological station is used to correct the estimated data from the evaporation model via a least square method and a regression method.

7. The evaluation method of glacier storage variation based on basin water-balance principle of claim 6, wherein the remote sense is NOAA/AVHRR and Landsat, the evaporation model is a SEBAL model, wherein a formula used by the SEBAL model is as below:
Rₙ=λ·ET+G+H
wherein, Rₙ is net radiant energy, G is soil heat flux, H is sensible heat flux, wherein these three parameters are inverted by VIS, NIR and TIR bands of remote sensing data respectively; λ is latent heat of vaporization of water, which is obtained by inquiring the query table of the latent heat of vaporization; and ET is evaporation capacity.

8. The evaluation method of glacier storage variation based on basin water-balance principle of claim 1, wherein the soil water storage variation in the step 2 is obtained by a method of remote sensing inversion and distributed hydrological simulation.

9. The evaluation method of glacier storage variation based on basin water-balance principle of claim 8, wherein, WEP model is used in the distributed hydrological simulation wherein a core algorithm uses Green-Ampt model and a formula is as below:
I=(θₛ−θᵢ)Z_{f}
wherein, I is cumulative infiltration capacity of the soil water, θₛ is saturated soil moisture content, θᵢ is initial soil moisture content, Z_{f} is depth degree of wetting front.

10. The evaluation method of glacier storage variation based on basin water-balance principle of claim 1, wherein the glacier storage variation of the basin of the step 4 is calculated with the following formula:
ΔV_{g}=(P−E−ΔVₛ−ΔVᵤ−Q)/k
wherein, ΔV_{g} is glacier storage variation, if it is positive, then the glacier storage increases, while if it is negative, then the glacier storage decreases; P is precipitation; E is evaporation; ΔVₛ is soil water storage variation, if it is positive, then the soil water storage increases, while if it is negative, then the soil water storage decreases; ΔVᵤ is groundwater storage variation, if it is positive, then the groundwater storage increases, while if it is negative, then the groundwater storage decreases, since the changes of the groundwater in glacier area is little, even none, ΔVᵤ is thus regarded as 0; Q is runoff of the basin; k is the phase transition coefficient and the density of ice is 0.9 g/cm³, k is generally taken as 0.9.
